(19) United States
(12) Patent Application Publication
(10) Pub. No.: US 2012/0003057 A1
(43) Pub. Date: Jan. 5, 2012

(54) WRENCHABLE DRILL BIT

(76) Inventor: Frank L. Leyba, Santa Ana, CA (US)

(21) Appl. No.: 13/175,703

(22) Filed: Jul. 1, 2011

Related U.S. Application Data
(60) Provisional application No. 61/361,281, filed on Jul. 2, 2010.

(51) Int. Cl. B23B 51/02; B23P 11/00

(52) U.S. Cl. 408/226; 408/199; 29/426.5

(57) ABSTRACT

A drill bit includes a shank at a first end of the drill bit, a boring head at a second end of the drill bit opposite the first end, and a wrenching section between the shank and the boring head. The wrenching section has a substantially different cross-section than any portion of the shank or the boring head. The wrenching section includes at least one pair of flat surfaces that are parallel to one another. In some embodiments, the wrenching section has a square or hexagonal cross section. A drill motor grips the shank for boring a hole in a workpiece. In some embodiments, the shank is cylindrical or splined, or is configured as an SDS shank, an SDS-plus shank, an SDS-Top shank, an SDS-max shank, or a Morse taper shank. A wrench is applied to the wrenching section to free the drill bit from the workpiece if jammed.

### CROSS REFERENCE TO RELATED APPLICATIONS

This application claims the benefit pursuant to 35 U.S.C. 119(e) of U.S. Provisional Application No. 61/361,281, filed Jul. 2, 2010, which application is specifically incorporated herein, in its entirety, by reference.

### BACKGROUND

1. Field

Embodiments of the invention relate to the field of rotating axially moving tools for cutting; and more specifically, to tools having a shank structure and a wrenchable structure to allow manually of driving of the tool with the wrenchable structure as an alternative to driving the tool from a shank structure.

2. Background

Rotating axially moving tools for cutting, such as drill bits of various types, are widely used for creating holes in a variety of materials. In particular, drill bits having diameters of up to several inches may be used with various types of drill motors that rotate the drill bit to prepare holes in various materials such as concrete, wood, or metal. Tool-infeed may be provided manually or by powered means.

In the course of cutting a hole is possible that the drill bit may become jammed in the workpiece. In some cases it may not be possible to free the drill bit using the drill motor. It may be necessary to apply a greater torque than is possible to provide with the drill motor, to rotate the drill bit in a direction opposite that provided by the drill motor, or otherwise manipulate the drill bit in ways not possible with the drill motor to free the drill bit.

Certain combinations of drill bit types and workpiece materials are more prone to jamming. For example, Forstner bits are used for cutting precise holes in wood. Forstner bits have a large portion of the circumference that fits closely within the hole being formed. As a result, a Forstner bit is prone to jamming if the workpiece and bit become misaligned during the drilling operation or if a chip gets caught between the bit and the formed hole. As another example, when drilling holes through reinforced concrete the bit may strike a piece of reinforcing steel, such as rebar, and the cutting edge of the drill bit, which is not well suited to cutting metal, may jam on the reinforcing steel. Also, pieces of aggregate may form large, strong chips that may rotate and jam the drill bit with a camming action before being ejected from the hole being formed.

The problem of a jammed drill bit may be particularly significant when using larger drill bits, such as drill bits having shanks larger than ½ inch in diameter, as they are typically driven by drill motors that deliver a substantial amount of force and therefore jam the drill bit such that an even greater force is required to free the drill bit. Further, such drill bits may be relatively expensive and the workpieces relatively valuable making it highly desirable to recover the drill bit and avoid damage to the workpiece. In some cases, a drill bit may be jammed to the extent that it is necessary to cut off the portion of the drill bit that extends from the workpiece and drill a new hole at an alternate location.

Therefore it would be desirable to provide a means for freeing a jammed drill bit.

### SUMMARY

A drill bit includes a shank at a first end of the drill bit, a boring head at a second end of the drill bit opposite the first end, and a wrenching section between the shank and the boring head. The wrenching section has a substantially different cross-section than any portion of the shank or the boring head. The wrenching section includes at least one pair of flat surfaces that are parallel to one another. In some embodiments, the wrenching section has a square or hexagonal cross section. A drill motor grips the shank for boring a hole in a workpiece. In some embodiments, the shank is cylindrical or splined, or is configured as an SDS shank, an SDS-plus shank, an SDS-Top shank, an SDS-max shank, or a Morse taper shank. A wrench is applied to the wrenching section to free the drill bit from the workpiece if jammed.

Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a plan view of a drill bit that embodies the invention.

FIG. 2 is a pictorial view of a portion of the drill bit shown in FIG. 1.

FIG. 3 is a plan view of another drill bit that embodies the invention.

FIG. 4 is an end view of the drill bit shown in FIG. 3.

FIG. 5 is a plan view of another drill bit that embodies the invention.

FIG. 6 is a pictorial view of a portion of the drill bit shown in FIG. 5.

FIG. 7 is a plan view of another drill bit that embodies the invention.

FIG. 8 is a pictorial view of a portion of the drill bit shown in FIG. 7.

FIG. 9 is a plan view of another drill bit that embodies the invention.

FIG. 10 is a pictorial view of a portion of the drill bit shown in FIG. 9.

FIG. 11 is a plan view of another drill bit that embodies the invention.

FIG. 12 is a pictorial view of a portion of the drill bit shown in FIG. 11.

FIG. 13 is a pictorial view of an open end wrench being used to free a drill bit that embodies the invention from a workpiece.

FIG. 14 is a pictorial view of two open end wrenches being used to free a drill bit that embodies the invention from a workpiece.

FIG. 15 is a pictorial view of a tap wrench being used to free a drill bit that embodies the invention from a workpiece.

### DETAILED DESCRIPTION

In the following description, numerous specific details are set forth.

However, it is understood that embodiments of the invention may be practiced without these specific details. In other instances, well-known circuits, structures and techniques have not been shown in detail in order not to obscure the understanding of this description.

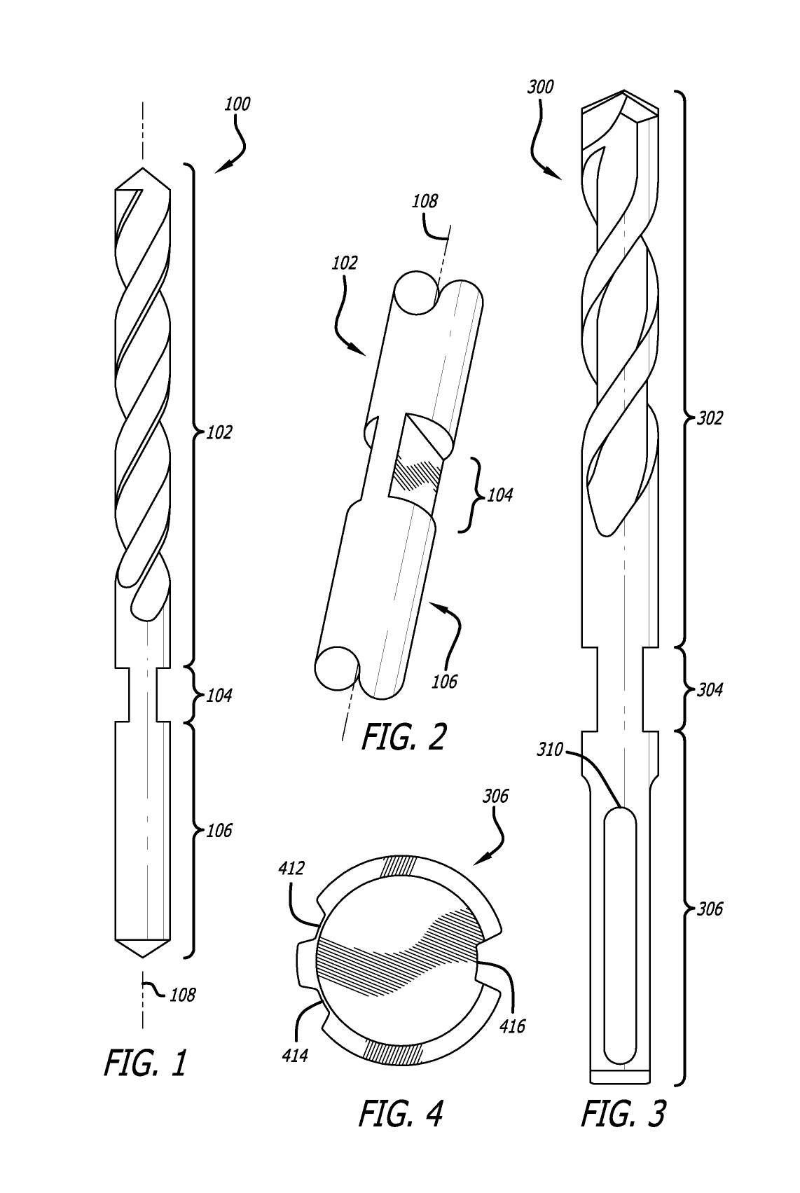

FIG. 1 shows a drill bit 100 that embodies the invention. The drill bit 100 includes a shank 106 at a first end of the drill bit, a boring head 102 at a second end of the drill bit opposite the first end, and a wrenching section 104 between the shank and the boring head. The wrenching section 104 has a substantially different cross-section than any portion of the shank 106 or the boring head 102. The wrenching section 104 includes at least one pair of flat surfaces that are parallel to one another and to a longitudinal axis 108 of the drill bit that extends from the shank 106 to the boring head 102. The cross-section of the wrenching section 104 is such that it provides surfaces that can be gripped securely by one or more open-end wrenches.

In the embodiment shown in FIG. 1, the shank 106 is a plain cylindrical section designed to be gripped by a three jaw chuck of a drill motor. It will be appreciated that the shank may be any of a variety of configurations suitable for gripping by various types of drill motors. In this embodiment the boring head 102 is a twist drill configuration with a pair of the cutting edges at the second end and helical chip clearing flutes leading away from the cutting edges toward the first end of the drill bit. It will be appreciated that the boring head may be any of a variety of configurations but that the invention is particularly suitable for use with boring heads that are prone to jamming in the workpiece.

FIG. 2 shows a pictorial view of the wrenching section 104 of this embodiment. In this embodiment, the wrenching section 104 provides one pair of flat surfaces that are parallel to one another and to a longitudinal axis 108 of the drill bit 100 that extends from the shank 102 to the boring head 106. In this embodiment the wrenching section 104 has the same diameter as the shank 102 and the boring head 106. Therefore the wrenching section 104 does not interfere with the function of the drill bit 100. The depth of the cuts that form the parallel flat surfaces of the wrenching section 104 are chosen to provide a sufficient flat area to allow a substantial torque to be applied to the drill bit 100 with a wrench to free a jammed drill bit while leaving a sufficient cross-section to transmit torque from the shank 102 to the boring head 106 during normal drilling operations. While the transitions from the shank 102 and the boring head 106 to the wrenching section 104 are shown as sharp corners for clarity, these transitions may be filleted to avoid stress concentrations at these transitions.

FIG. 3 shows another drill bit 300 that embodies the invention. The drill bit 300 is substantially similar to the drill bit shown in FIG. 1 with a shank 306 at a first end of the drill bit, a boring head 302 at a second end of the drill bit opposite the first end, and a wrenching section 304 between the shank and the boring head. In this embodiment the shank 306 is an SDS (“Steck—Dreh—Sitz,” German for “Insert—Twist—Stay”) Max configuration.

FIG. 4 is an end view of the drill bit 300 shown in FIG. 3 from the shank 306 end. The three sliding keyways 412, 414, 416 that are part of the SDS-Max shank configuration may be seen in the end view. The SDS-Max shank configuration also includes two indentations 310 that do not open to the end, one of which can be seen in FIG. 3. The indentations 310 are grasped by the chuck to prevent the drill bit falling out. This configuration allows the chuck to transmit rotational forces to the drill bit while allowing the drill bit to slide axially within the chuck to deliver a hammering action.

The various SDS shank configurations, SDS, SDS-plus, SDS-Top, and SDS-Max, are particularly suitable for use on rotary hammer drill bits used to drill concrete and masonry. As previously discussed, rotary hammer drill bits are particularly prone to jamming. In larger sizes, such as drill bits having shanks larger than ½ inch in diameter, considerable force may be required to free a jammed rotary hammer drill bit.

The wrenching section 304 allows a wrench to be securely applied to the drill bit 300 to work a jammed drill bit free from the workpiece. Providing a wrenching section 304 for the application of manual forces to free a jammed drill bit 300 discourages the use of ad hoc methods of gripping the drill bit that may damage the boring head 302 or the shank 306 and render the drill bit unusable. It will be appreciated that gripping an SDS shank configuration for freeing a jammed drill bit is particularly likely to damage the shank such that it will not slide freely in the SDS type drill chuck and, in severe cases, cannot be correctly held by the chuck.

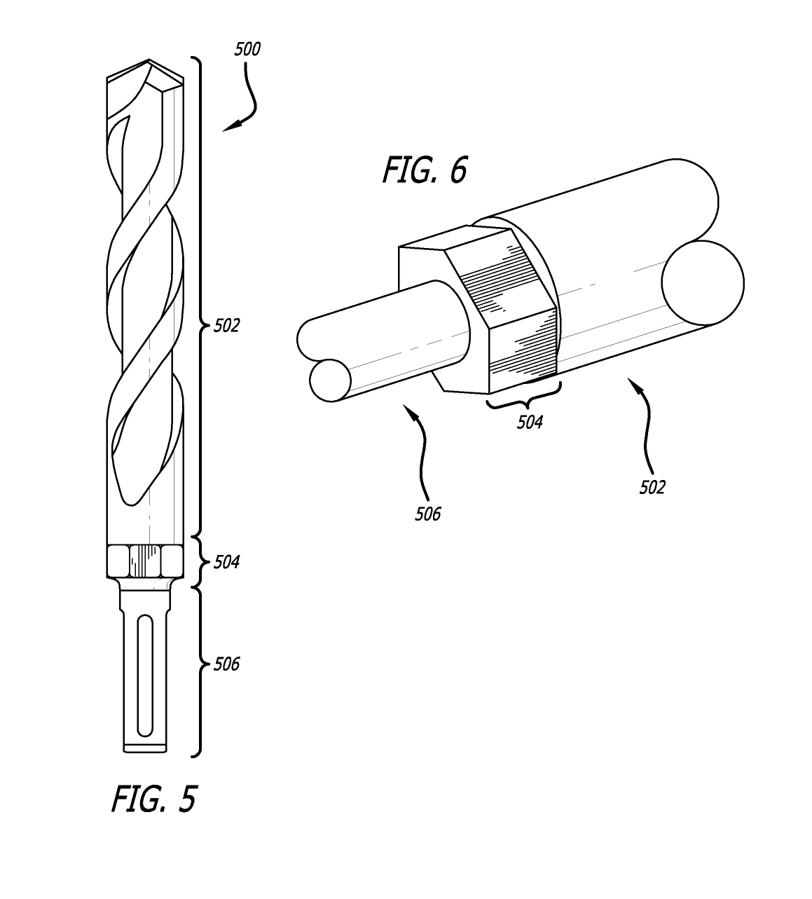

FIG. 5 shows another drill bit 500 that embodies the invention. The drill bit 500 is substantially similar to the drill bit shown in FIG. 1 with a shank 506 at a first end of the drill bit, a boring head 502 at a second end of the drill bit opposite the first end, and a wrenching section 504 between the shank and the boring head. In this embodiment the shank 506 is an SDS-plus configuration shank that has a smaller diameter than the boring head 502. Even though the SDS-plus configuration shank has a smaller diameter of approximately ⅜ of an inch, it can still deliver a substantial twisting force to the boring head because of the keyways on the shank.

FIG. 6 shows a pictorial view of the wrenching section 504 of this embodiment. In this embodiment, the wrenching section 504 has a regular hexagonal cross-section that provides three pairs of flat surfaces. In this embodiment, the diameter of the boring head 502 is substantially the same or slightly greater than the diameter of a circle that circumscribes the regular hexagon of the cross-section. Thus the wrenching section 504 does not interfere with the function of the boring head 502.

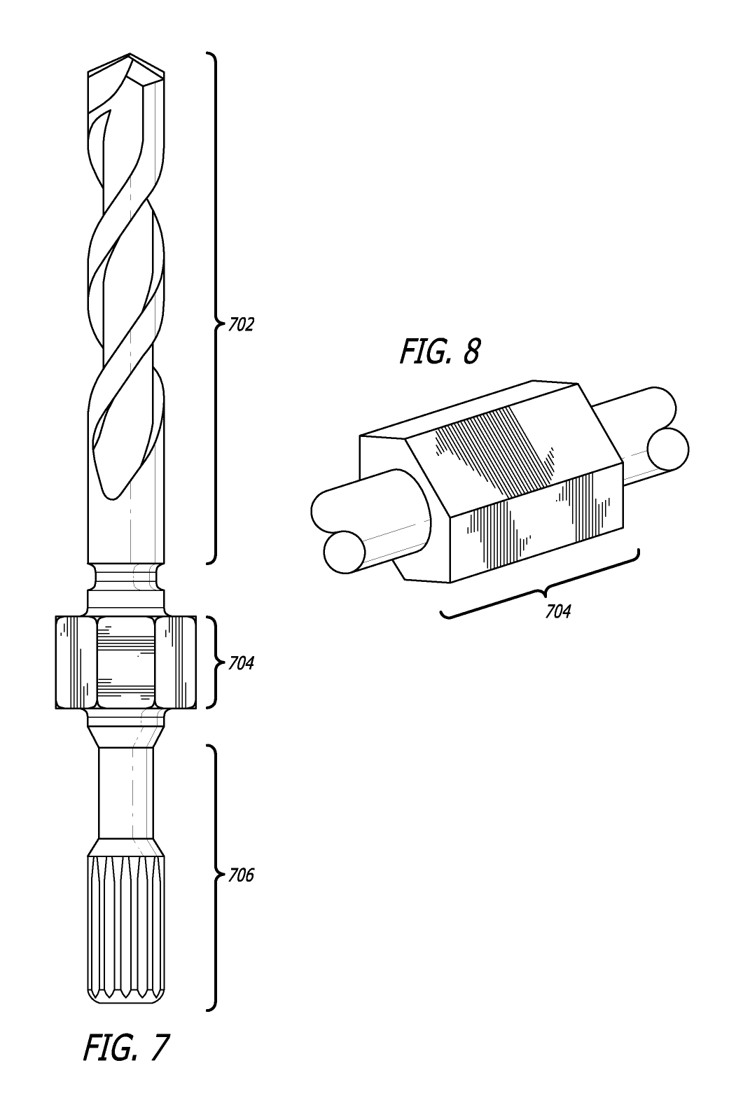

FIG. 7 shows another drill bit 700 that embodies the invention. The drill bit 700 is substantially similar to the drill bit shown in FIG. 1 with a shank 706 at a first end of the drill bit, a boring head 702 at a second end of the drill bit opposite the first end, and a wrenching section 704 between the shank and the boring head. In this embodiment the shank 706 is a splined shank.

FIG. 8 shows a pictorial view of the wrenching section 704 of this embodiment. In this embodiment, the wrenching section 704 has a regular hexagonal cross-section that provides three pairs of flat surfaces. In this embodiment, the diameter of the boring head 702 is substantially less than the diameter of a circle that circumscribes the regular hexagon of the cross-section. The relatively large size of the wrenching section 704 allows a high torque to be applied for freeing a jammed drill bit 700. The wrenching section 704 may have a sufficient length to permit two wrenches to be applied to the wrenching section.

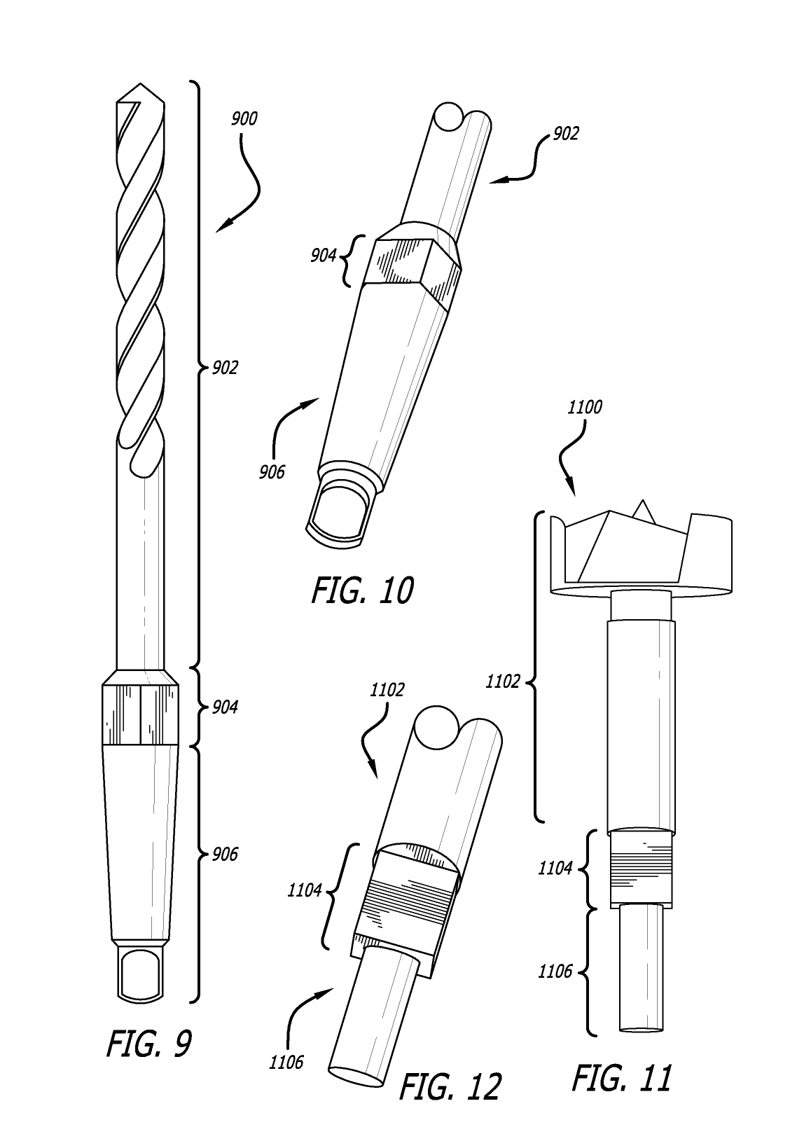

FIG. 9 shows another drill bit 900 that embodies the invention. The drill bit 900 is substantially similar to the drill bit shown in FIG. 1 with a shank 906 at a first end of the drill bit, a boring head 902 at a second end of the drill bit opposite the first end, and a wrenching section 904 between the shank and the boring head. In this embodiment the shank 906 is a Morse taper shank.

FIG. 10 shows a pictorial view of the wrenching section 904 of this embodiment. In this embodiment, the wrenching section 904 has a substantially square cross-section that provides two pairs of flat surfaces. The square wrenching section 904 permits a tap wrench to be used as an alternative to an open end wrench for freeing a jammed drill bit.

FIG. 11 shows another drill bit 1100 that embodies the invention. The drill bit 1100 is a Forstner drill bit with a shank 1106 at a first end of the drill bit, a boring head 1102 at a second end of the drill bit opposite the first end, and a wrenching section 1104 between the shank and the boring head. It may be seen that a substantial part of the boring head is a non-cutting extension that extends the depth to which the cutting and chip clearing portions of the boring head can be advanced into the workpiece.

FIG. 12 shows a pictorial view of the wrenching section 1104 of this embodiment. In this embodiment, the wrenching section 1104 has a substantially square cross-section that provides two pairs of flat surfaces. The square wrenching section 1104 permits a tap wrench to be used as an alternative to an open end wrench for freeing a jammed drill bit. The use of a tap wrench may be advantageous for freeing a jammed Forstner drill bit since these bits are used for drilling precision holes in wood and a tap wrench allows greater control of the axial alignment of the drill bit as it is freed from the workpiece.

Any drill bit that embodies the invention may be used to drill a hole in a workpiece by gripping a shank at a first end of the drill bit with a drill motor having a chuck appropriate for gripping the shank. A hole is bored in the workpiece with a boring head at a second end of the drill bit opposite the first end by operation of the drill motor to rotate the drill bit as it is advanced into the workpiece either manually or by mechanical means. In the event that the drill bit becomes jammed in the workpiece such that the drill motor is unable to move the drill bit and it is not possible to remove the drill bit from the workpiece, it may be possible to turn the drill bit with a wrench applied to a wrenching section between the shank and the boring head to free the drill bit from the workpiece. The location of the wrenching section between the shank and the boring head allow a wrench to be applied without removing the drill bit shank from the drill motor. This may be desirable for maintaining the tool setup and/or using the drill motor to maintain the alignment of the drill bit to the workpiece.

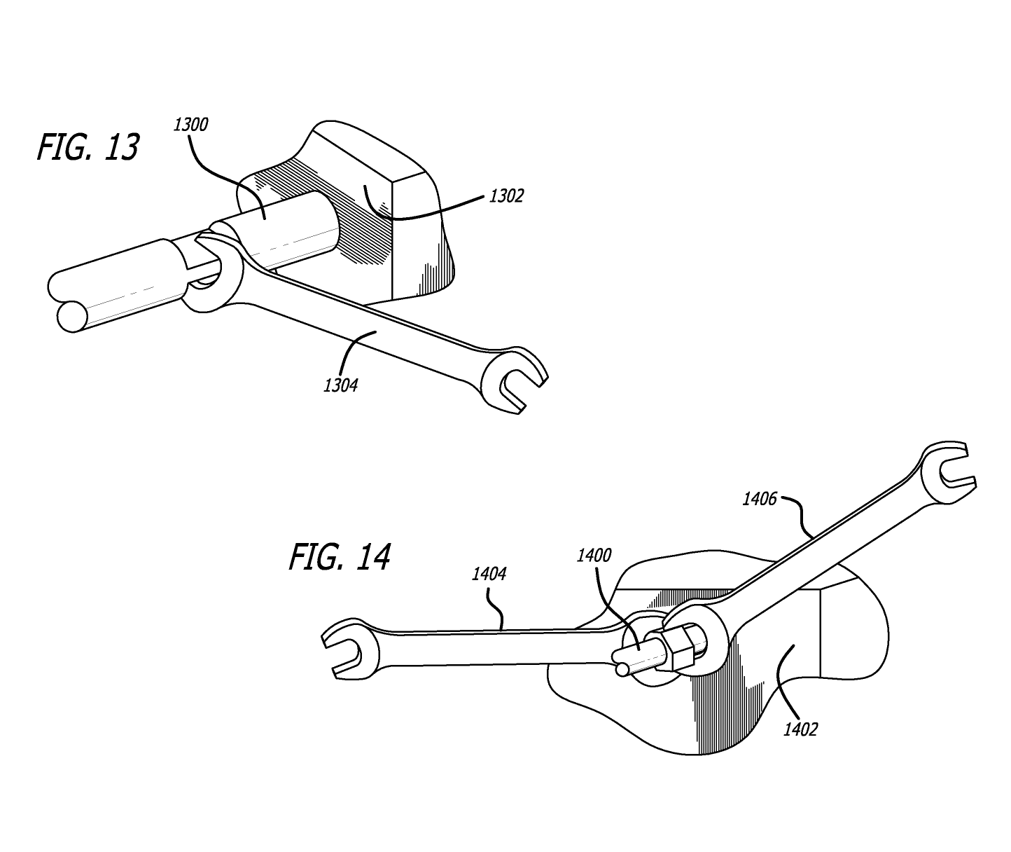

FIG. 13 shows an open end wrench 1304 applied to a drill bit 1300 of the type shown in FIGS. 1 and 3. The wrench 1304 can apply a substantial twisting force to the drill bit 1300 to free the drill bit from the workpiece 1302.

FIG. 14 shows two open end wrenches 1404, 1406 applied to a drill bit 1400 of the type shown in FIG. 7. The use of two wrenches 1404, 1406 allows a greater twisting force to be applied to the drill bit 1400 to free the drill bit from the workpiece 1402. Applying the two open end wrenches 1404, 1406 from substantially opposite directions as shown may reduce the tendency to press the boring head of the drill bit 1400 against the side of the hole in the workpiece and make it easier to free the drill bit from the workpiece 1402.

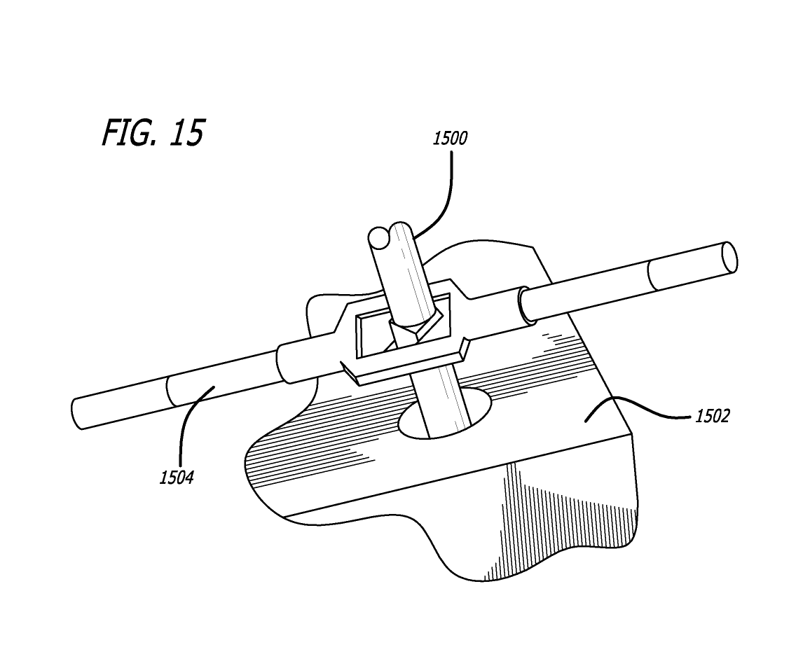

FIG. 15 shows a tap wrench 1504 applied to a drill bit 1500 of the type shown in FIG. 11. The tap wrench 1504 can apply a substantial twisting force to the drill bit 1500 to free the drill bit from the workpiece 1502 because of the two handles it provides. The tap wrench 1504 allows greater control of the axial alignment of the drill bit 1500 which may aid in freeing the drill bit from the workpiece 1502 with less risk of damage to the workpiece.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A drill bit comprising:
a shank at a first end of the drill bit;
a boring head at a second end of the drill bit opposite the first end; and
a wrenching section between the shank and the boring head, the wrenching section having a substantially different cross-section than any portion of the shank and the boring head, the wrenching section including at least one pair of flat surfaces that are parallel to one another and to a longitudinal axis of the drill bit that extends from the shank to the boring head.

2. The drill bit of paragraph 1 wherein the wrenching section includes two pairs of flat surfaces that are parallel to one another and to a longitudinal axis of the drill bit that extends from the shank to the boring head, the two pairs of surfaces being at right angles to form a square cross section.

3. The drill bit of paragraph 1 wherein the wrenching section includes three pairs of flat surfaces that are parallel to one another and to a longitudinal axis of the drill bit that extends from the shank to the boring head, the three pairs of surfaces forming a hexagonal cross section.

4. The drill bit of paragraph 1 wherein the shank is cylindrical.

5. The drill bit of paragraph 1 wherein the shank is splined.

6. The drill bit of paragraph 1 wherein the shank is configured as one of an SDS shank, an SDS-plus shank, an SDS-Top shank, or an SDS-max shank.

7. The drill bit of paragraph 1 wherein the shank is configured as a Morse taper shank.

8. A drill bit comprising:
means for gripping the drill bit with a drill motor at a first end of the drill bit;
means for boring a hole in a workpiece at a second end of the drill bit opposite the first end; and
means for turning the drill bit with an open-end wrench between the means for gripping the drill bit with a drill motor and the means for boring a hole, the means for turning the drill bit with an open-end wrench having a substantially different cross-section than any portion of the means for gripping the drill bit with a drill motor and the means for boring a hole, the means for turning the drill bit including at least one pair of flat surfaces that are parallel to one another and to a longitudinal axis of the drill bit that extends from the shank to the boring head.

9. The drill bit of paragraph 8 wherein the means for turning the drill bit with a wrench has a square cross section.

10. The drill bit of paragraph 8 wherein the means for turning the drill bit with a wrench has a hexagonal cross section.

11. The drill bit of paragraph 8 wherein the means for gripping the drill bit is cylindrical.

12. The drill bit of paragraph 8 wherein the means for gripping the drill bit is splined.

13. The drill bit of paragraph 8 wherein the means for gripping the drill bit is configured as one of an SDS shank, an SDS-plus shank, an SDS-Top shank, or an SDS-max shank.

14. The drill bit of paragraph 8 wherein the means for gripping the drill bit is configured as a Morse taper shank.

15. A method for freeing a drill bit from a workpiece, the method comprising:
gripping a shank at a first end of the drill bit with a drill motor;
boring a hole in the workpiece with a boring head at a second end of the drill bit opposite the first end by operation of the drill motor; and
turning the drill bit with a wrench applied to a wrenching section between the shank and the boring head, the wrenching section having a substantially different cross-section than any portion of the shank and the boring head, the wrenching section including at least one pair of flat surfaces that are parallel to one another and to a longitudinal axis of the drill bit that extends from the shank to the boring head.

16. The method of paragraph 15 wherein turning the drill bit with a wrench further comprises turning the drill bit with an open end wrench applied to a wrenching section having at least one pair of flat surfaces that are parallel to one another and to a longitudinal axis of the drill bit.

17. The method of paragraph 15 wherein turning the drill bit with a wrench further comprises turning the drill bit with two open end wrenches applied to the wrenching section, the two open end wrenches being applied from substantially opposite directions.

18. The method of paragraph 15 wherein the wrenching section has a square cross section and turning the drill bit with a wrench further comprises turning the drill bit with a tap wrench applied to the wrenching section.
